(19) United States
(12) Patent Application Publication
(10) Pub. No.: US 2009/0047065 A1
(43) Pub. Date: Feb. 19, 2009

(54) Expandable and extractable positioning device for use in tubular members

(76) Inventor: Ku-Chia Cheng, Changhua City (TW)

Correspondence Address: PRO-TECHTOR INTERNATIONAL SERVICES, 20775 NORADA CT., SARATOGA, CA, 95070, US

(21) Appl. No.: 11/893,523

(22) Filed: Aug. 16, 2007

(51) Int. Cl. B25B 7/00

(52) U.S. Cl. 403/370; 81/427.5

(57) ABSTRACT

An expandable and retractable positioning device for use in tubular members comprises a first tubular member including a receiving mount received at the rear end thereof and having a control knob fitted at the rear end thereof, for receiving an elongated rack at the front end thereof, and for further inserting the rack into the first tubular member, and a second tubular member fitted in the first tubular member and including a support seat mounted at the rear end thereof and having a through hole formed thereon for the insertion of the rack, and having compartments for communicating with the through hole mounted at the peripheral side thereof and each having a toothed block placed therein. Besides, the toothed block includes engaging teeth arranged on the inner side thereof, such that the adjustable positioning purpose of the tubular members may be obtained.

### BACKGROUND OF THE INVENTION

1. Field of the Invention

The present invention relates to an expandable and retractable positioning device for use in tubular members that may effectively obtain the adjustable positioning purpose.

2. Description of the Prior Arts

Referring to FIG. 1, a prior art shear for use in gardening comprises first and second blades 11, 12 crossly disposed together and including rod members 13, 14 provided at the rear ends thereof respectively for a gripping purpose. To provide a length adjustable purpose, the rod members 13, 14 are formed of first tubular members 131, 141 and second tubular members 132, 142. The front ends of the first tubular members 131, 141 are mounted at the rear ends of the first and second blades 11, 12, and the second tubular members 132, 142 include control knobs 133, 143 for a positioning purpose mounted at the rear ends thereof so that the first tubular members 131, 141 and the second tubular members 132, 142 may be adjusted to a proper length and positioned.

As shown in FIGS. 2 and 3, TW Appl. No. 89216185 to Zheng discloses a prior art expandable and retractable rod member including a first tubular member 20 having a holder 21 provided at the rear end thereof. The holder 21 includes a fitting portion 211 for cooperating with the first tubular member 20 disposed at the front end thereof (e.g., if the first tubular member 20 is constructed in the shape of an ellipse, then the fitting portion 211 is made in the shape of an ellipse), and includes a coupling bulge 212 mounted at the rear end thereof. The fitting portion 211 and the coupling bulge 212 includes a through hole 213 arranged therein. A control knob 22 is affixed at the rear end of the holder 21, and includes a fitting portion 221 for being fitted into the through hole 213 formed at the front end thereof, and includes a retained 222 attached at the end portion thereof, by which the control knob 22 allows to be retainer at the rear end of the holder 21, and includes a rotatable member 223 defined at the rear end thereof and having a spring 224 and a ball 225 received at the front end thereof, such that as the rotation of the control knob 22, the ball 225 may align with one of orifices 214 of the holder 21. The control knob 22 further includes a polygonal bore 226 arranged therein and having a polygonal stem 23 received therein, hence as rotating the rotatable member 223, the control knob 22 turns along the holder 21 so as to actuate the rotation of the polygonal stem 23. A second tubular member 24 for being fitted in the first tubular member 20 includes a support seat 25 fitted at the rear end thereof and having a fitting portion 251 arranged at the front end thereof for cooperating with the second tubular member 24 (e.g., if the second tubular member 24 is constructed in the shape of an ellipse, then the fitting portion 251 is made in the shape of an ellipse), and includes a connecting portion 252 formed at the rear end thereof. The fitting portion 251 and the connecting portion 252 include a through opening 253 affixed therein. An actuation member 26 attached at the rear end of the support seat 25 includes an insertion 261 disposed at the front end thereof for being inserted into the through opening 253 and having a retainer 262 formed at the front end thereof, by which the actuation member 26 may be retained at the rear end of the support seat 25. The actuation member 26 includes an eccentric block 263 mounted at the rear end of the insertion 261 and having an eccentric roller 27 secured therearound, such that the eccentric roller 27 permits to be rotated along the support seat 25. In addition, the actuation member 26 further includes a polygonal hole 264 attached therein for the insertion of the polygonal stem 23.

As illustrated in FIGS. 4 and 5, during the length adjustment of tubular members, the first tubular member 20 is pulled out backward so as to urge the polygonal stem 23 to move. Thereafter, as the positioning of the tubular members, the rotatable member 223 is turned to actuate the rotation of the actuation member 26 with polygonal stem 23, thereby the eccentric roller 27 contacts the inner wall of the first tubular member 20 for obtaining the positioning purpose. However, such a prior art positioning device can not securely engage with the inner wall of the first tubular member 20 to cause a slidable disengagement.

The present invention has arisen to mitigate and/or obviate the afore-described disadvantages.

### SUMMARY OF THE INVENTION

The primary object of the present invention is to provide an expandable and retractable positioning device for use in tubular members that may effectively obtain the adjustable positioning purpose of the tubular members.

The secondary object of the present invention is to provide an expandable and retractable positioning device for use in tubular members that may prevent the disengagement of the tubular members for achieving a positioning purpose.

In accordance with one aspect of the present invention, there is provided an expandable and retractable positioning device for use in tubular members comprising a first tubular member including a receiving mount received at the rear end thereof and having a control knob fitted at the rear end thereof, for receiving an elongated rack at the front end thereof, and for further inserting the rack into the first tubular member, and a second tubular member fitted in the first tubular member including a support seat mounted at the rear end thereof and having a through hole formed thereon for the insertion of the rack, and having compartments for communicating with the through hole, each having a toothed block placed therein. Besides, the toothed block includes engaging teeth arranged on the inner side thereof, such that the adjustable positioning purpose of the tubular members may be obtained.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram of a prior art shear for use in gardening;

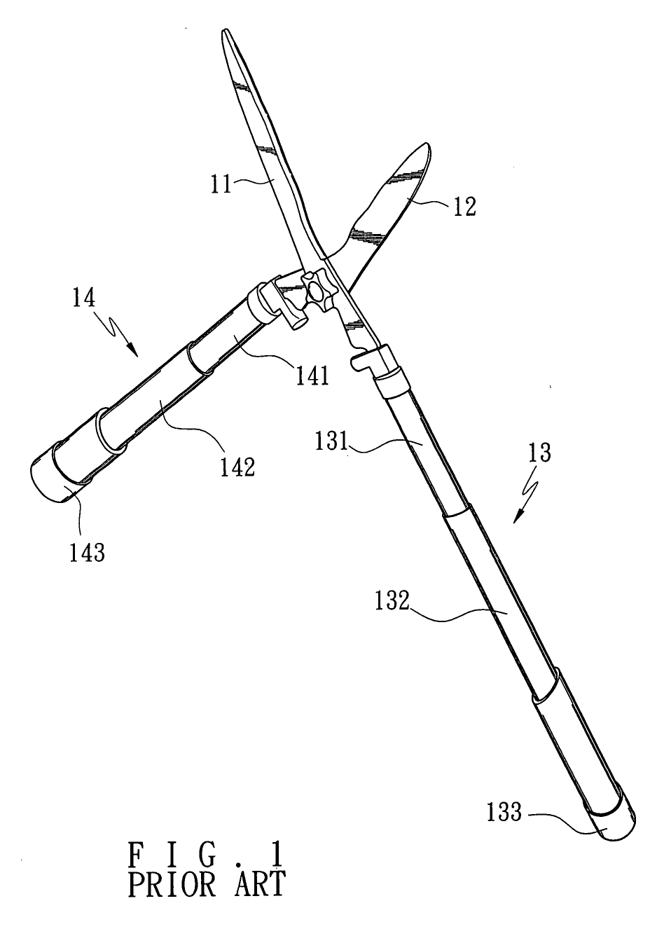

FIG. 2 is a perspective diagram illustrating the exploded components of a prior art expandable and retractable rod member of TW Appl. No. 89216185;

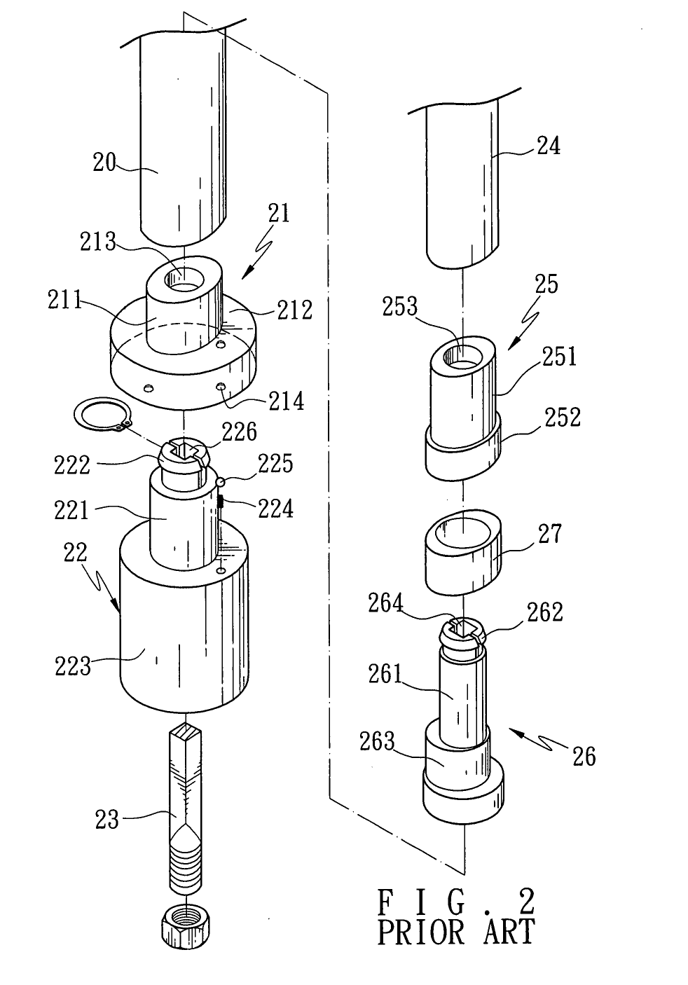

FIG. 3 is a cross sectional diagram illustrating the assembly of the prior art expandable and retractable rod member of TW Appl. No. 89216185;

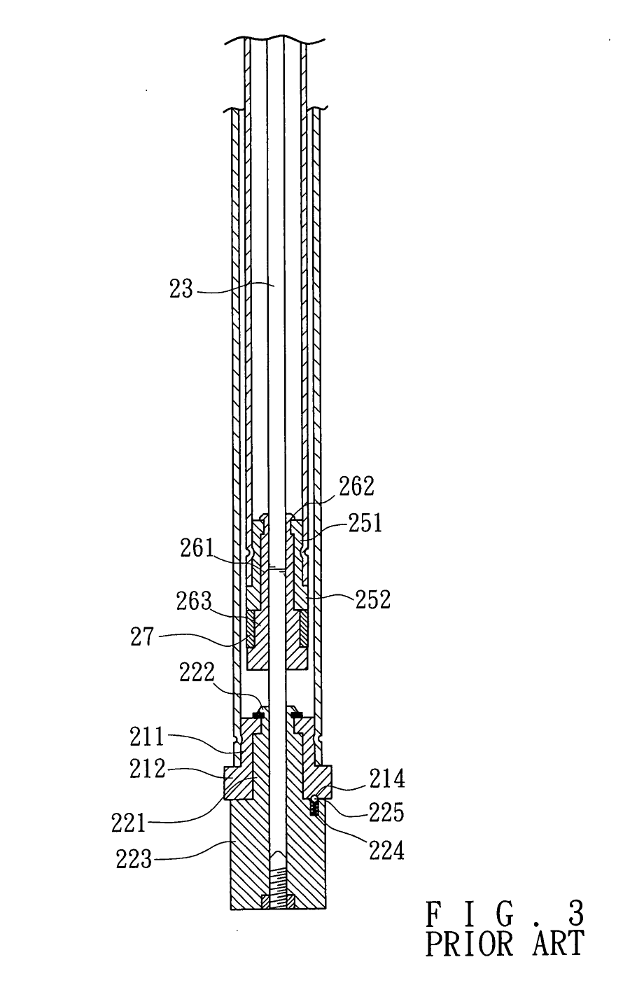

FIG. 4 is a cross sectional diagram illustrating the length of the prior art expandable and retractable rod member of TW Appl. No. 89216185 being adjustable;

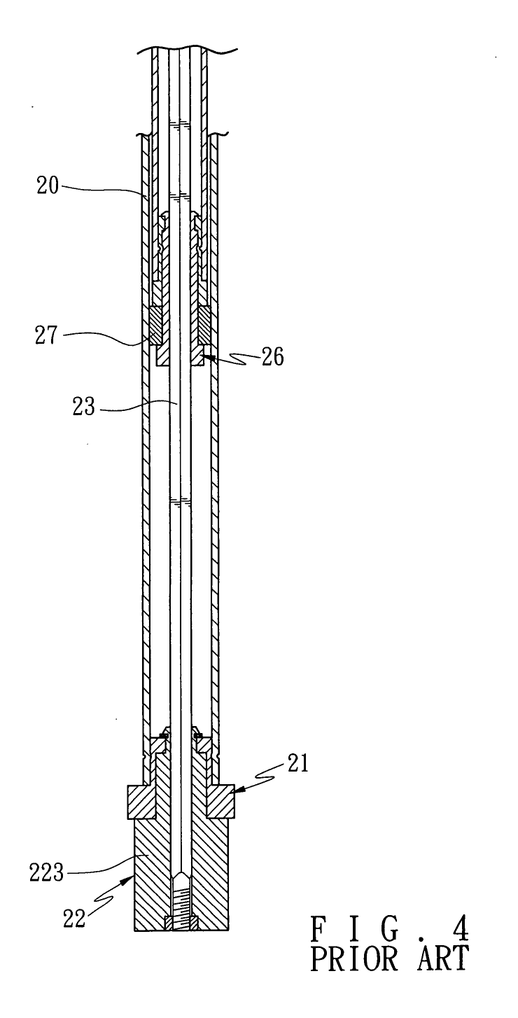

FIG. 5 is a cross sectional diagram illustrating the prior art expandable and retractable rod member of TW Appl. No. 89216185 being adjustably positioned;

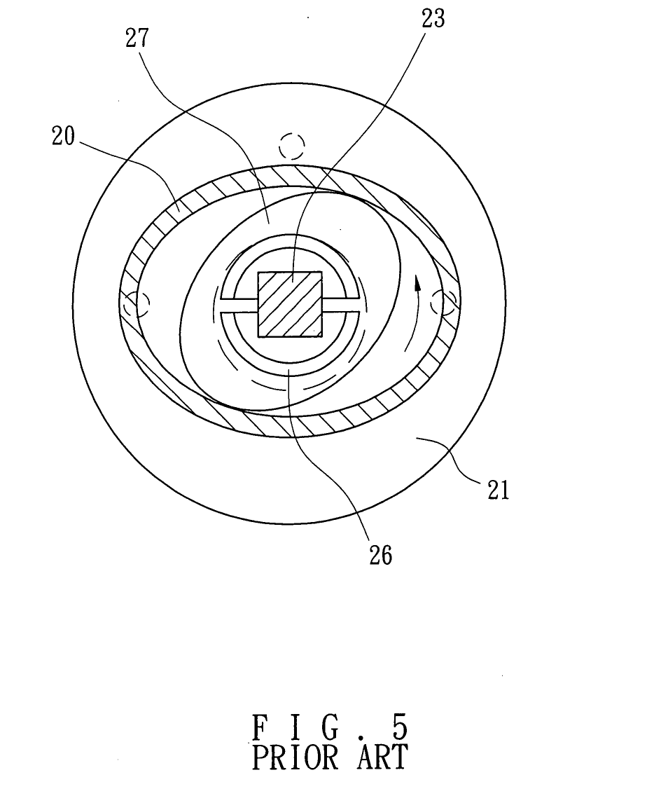

FIG. 6 is a perspective diagram illustrating the exploded components of an expandable and retractable positioning device for use in tubular members according to the present invention;

FIG. 7 is a perspective diagram illustrating the assembly of the expandable and retractable positioning device for use in tubular members according to the present invention;

FIG. 8 is another perspective diagram illustrating the assembly of the expandable and retractable positioning device for use in tubular members according to the present invention;

FIG. 9 is a cross sectional diagram illustrating the length of first and second tubular members of the present invention being adjustable;

FIG. 10 is a cross sectional diagram illustrating the first and second tubular members of the present invention being positioned after the length's adjustment;

FIG. 11 is a cross sectional diagram of the first and second tubular members of the present invention, taken along lines A-A of FIG. 10;

FIG. 12 is a perspective diagram illustrating the exploded components of an expandable and retractable positioning device for use in tubular members according to another embodiment of the present invention;

FIG. 13 is a perspective diagram illustrating the assembly of the expandable and retractable positioning device for use in tubular members according to another embodiment of the present invention;

FIG. 14 is another perspective diagram illustrating the assembly of the expandable and retractable positioning device for use in tubular members according to another embodiment of the present invention;

FIG. 15 is a cross sectional diagram illustrating the first and second tubular members of another embodiment of the present invention being positioned after the length's adjustment;

FIG. 16 is a cross sectional diagram of the first and second tubular members of another embodiment of the present invention, taken along lines B-B of FIG. 15.

### DETAILED DESCRIPTION OF THE PREFERRED EMBODIMENT

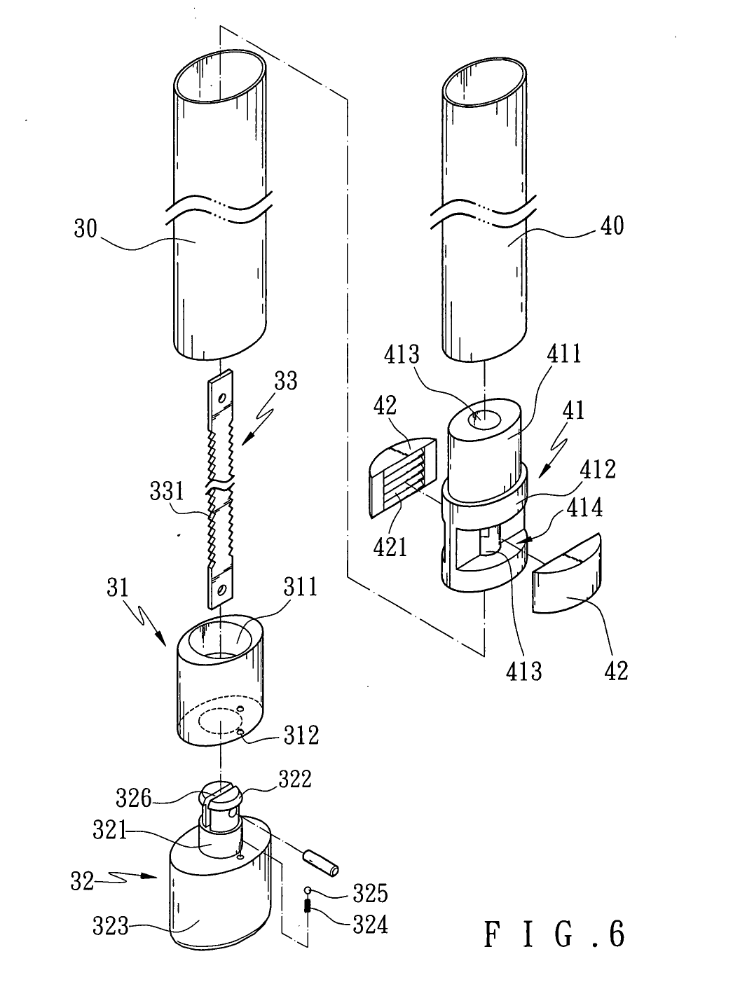

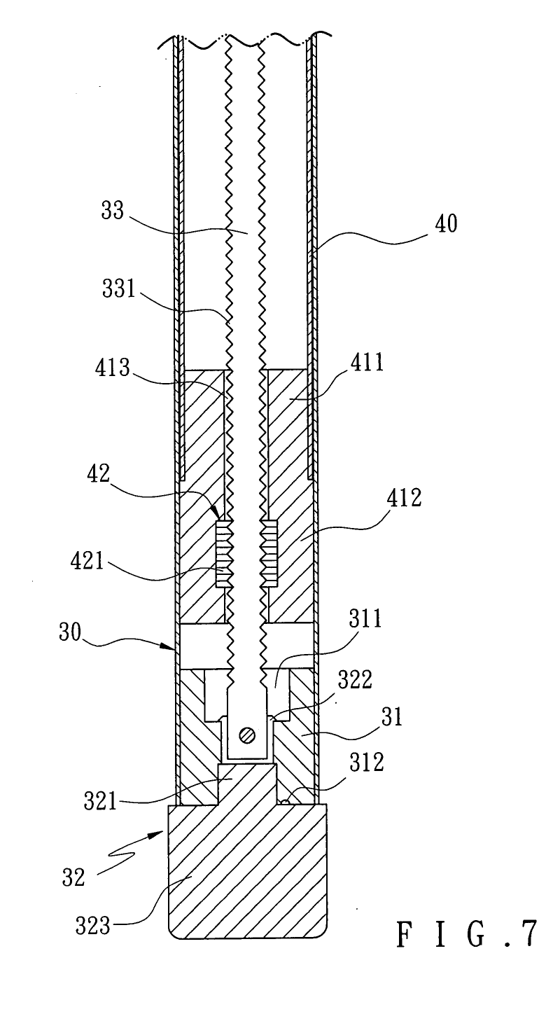

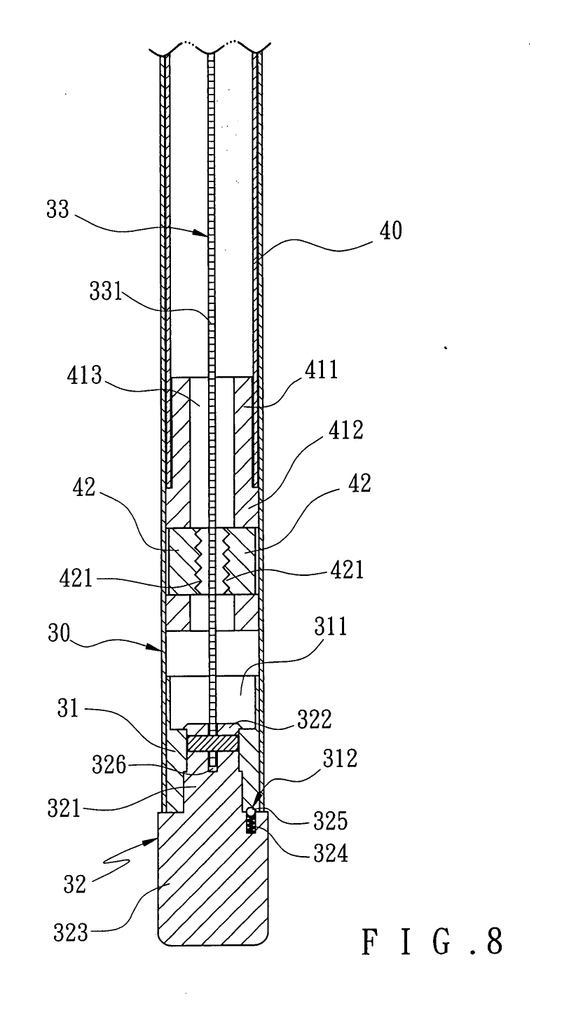

Referring to FIGS. 6-8, an expandable and retractable positioning device for use in tubular members in accordance with the present invention comprises a first tubular member 30 including a receiving mount 31 received at the rear end thereof and constructed in a predetermined shape for the cooperation with the tubular member 30 (e.g., if the first tubular member 30 is constructed in the shape of an ellipse, then the receiving mount 31 is made in the shape of an ellipse), such that the receiving mount 31 may be received at the rear end of the first tubular member 30. The receiving mount 31 includes a hole 311 formed therethrough, and includes a control knob 32 fitted at the rear end thereof and having an insertion 321 provided at the front end thereof for being inserted in the hole 311 of the receiving mount 31, the insertion 321 includes a retainer 322 affixed at the front end thereof, by which the control knob 32 is retained at the rear end of the receiving mount 31. Besides, the control knob 32 involves a rotatable member 323 secured at the rear end thereof and having a spring 324 and a fastening ball 325 defined at the front end thereof such that during the rotation, the fastening ball 325 allows to align with the orifice 312 of the receiving mount 31, and the insertion 321 further includes a slot 326 arranged thereon for receiving an elongated rack 33 having teeth 331 arranged at one side or two sides thereof such that during the rotation of the rotatable member 323, the control knob 32 may turn along the receiving mount 31 to urge the rotation of the rack 33. A second tubular member 40 for being fitted in the first tubular member 30 includes a support seat 41 attached at the rear end thereof and having a fitting portion 411 fixed at the front end thereof for associating with the second tubular member 40 (e.g., if the second tubular member 40 is constructed in the shape of an elliptic cylinder, the fitting portion 411 is made in the shape of an ellipse), and having a holding member 412 disposed at the rear end thereof. Between the fitting portion 411 and the holding member 412 is provided with a through hole 413 for inserting the rack 33 into the second tubular member 40. The holding member 412 contains compartments 414 for communicating with the through hole 413 mounted at the peripheral side thereof and each having a toothed block 42 placed therein and lower than the outer surface of the holding member 412. The toothed block 42 includes engaging teeth 421 arranged on the inner side thereof relative to the through hole 413 for a tiny displacement in the compartment 414.

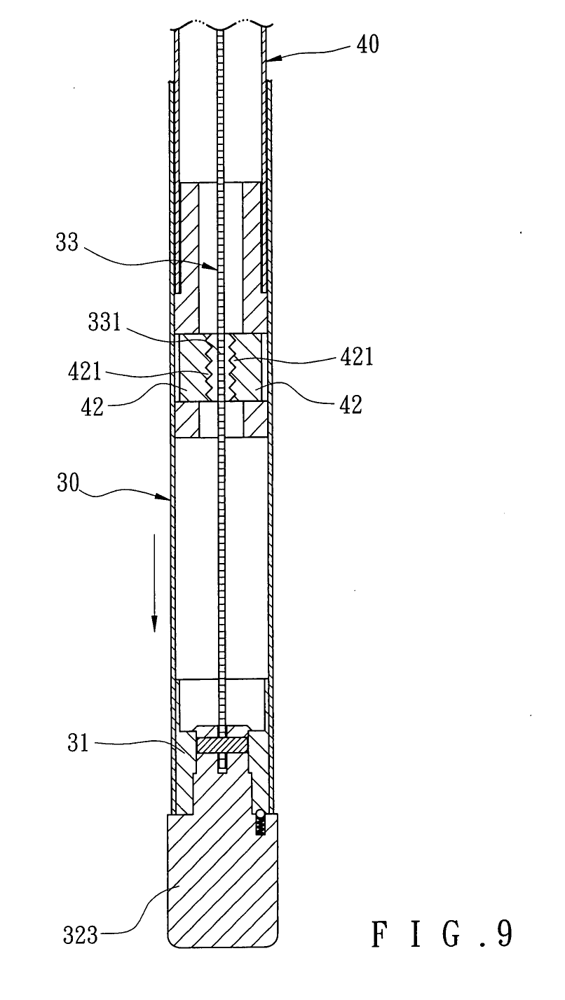

As shown in FIG. 9, as adjusting the length of the tubular members, because the teeth 331 of the rack 33 do not engage with the toothed block 42, the first tubular member 30 may be pulled out backward so as to urge the rack 33 to move backward, thus obtaining the desired length.

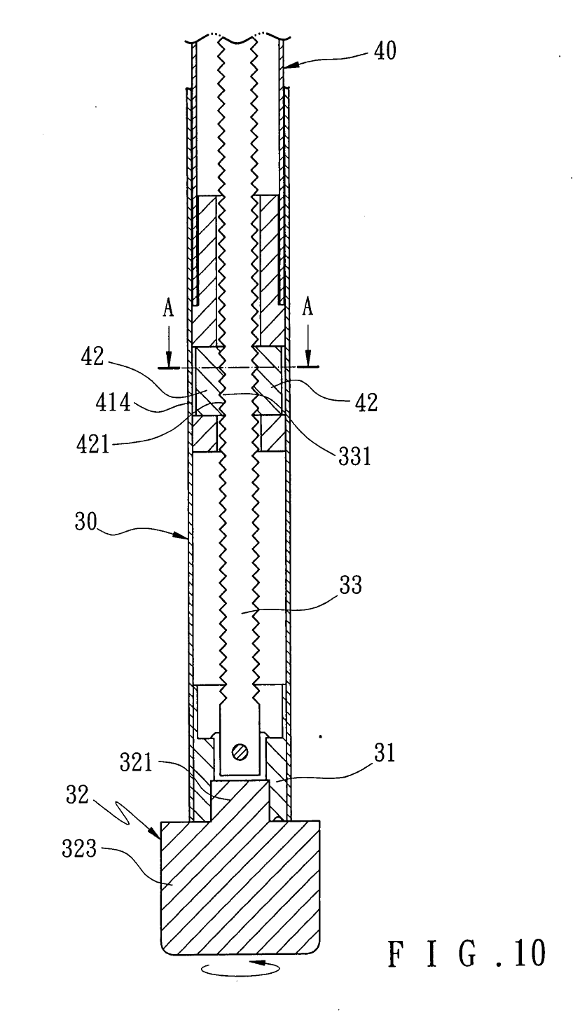

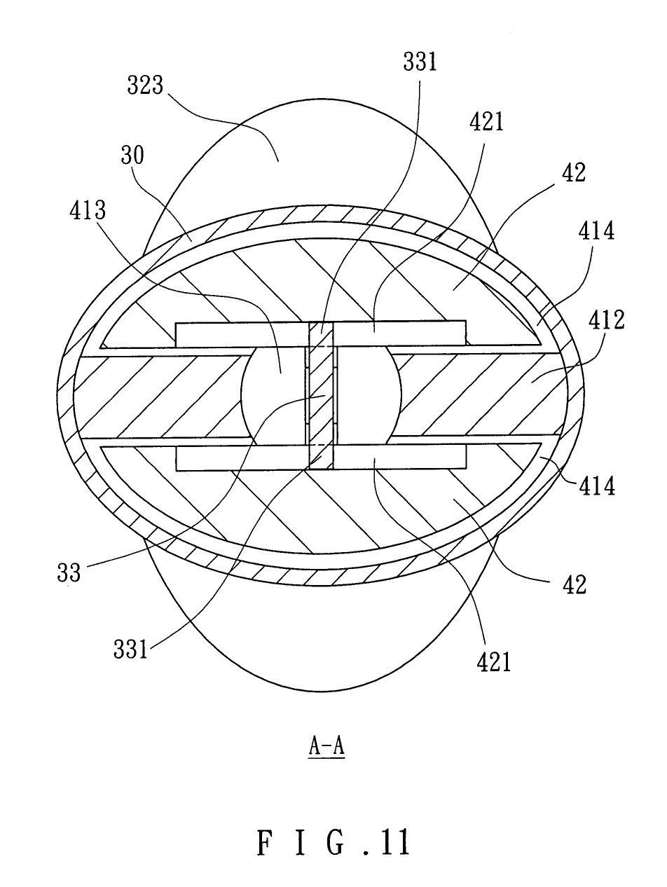

As illustrated in FIGS. 10 and 11, behind the length's adjustment of the tubular members, the rotatable member 323 permits to be turned to actuate the rotation of the rack 33 so that the teeth 331 intersects with the engaging teeth 421 of the toothed block 42. Since the toothed block 42 may cause a tiny displacement in the compartment 414, while the teeth 331 of the rack 33 rotatably intersects with the engaging teeth 421, it may further engage with the engaging teeth 421, obtaining the adjustable positioning purpose of the tubular members.

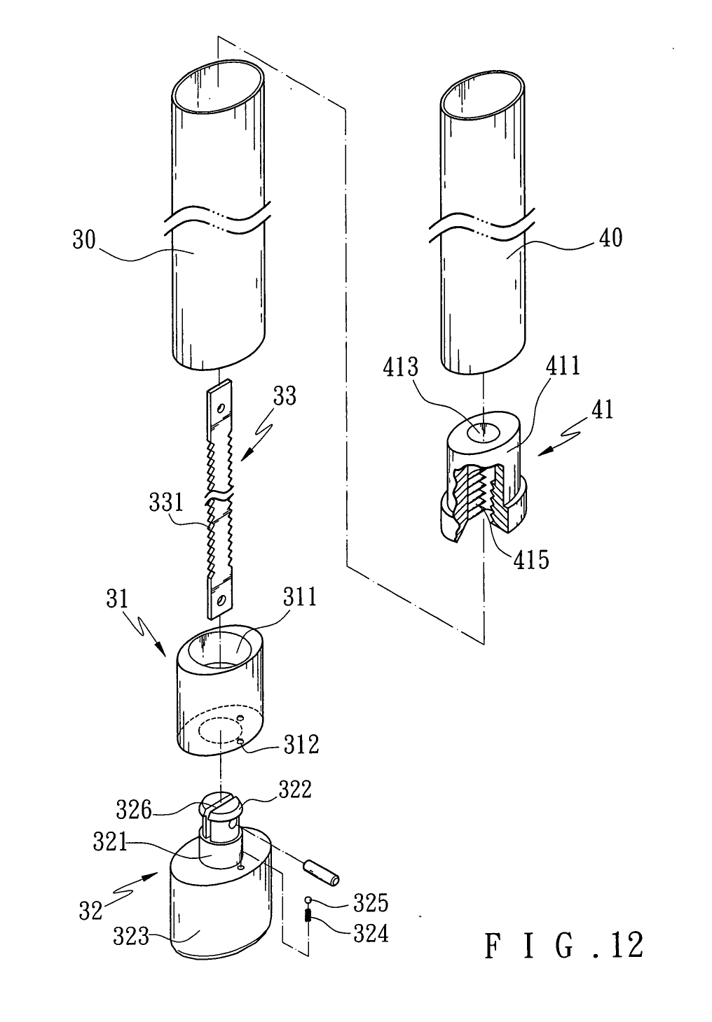

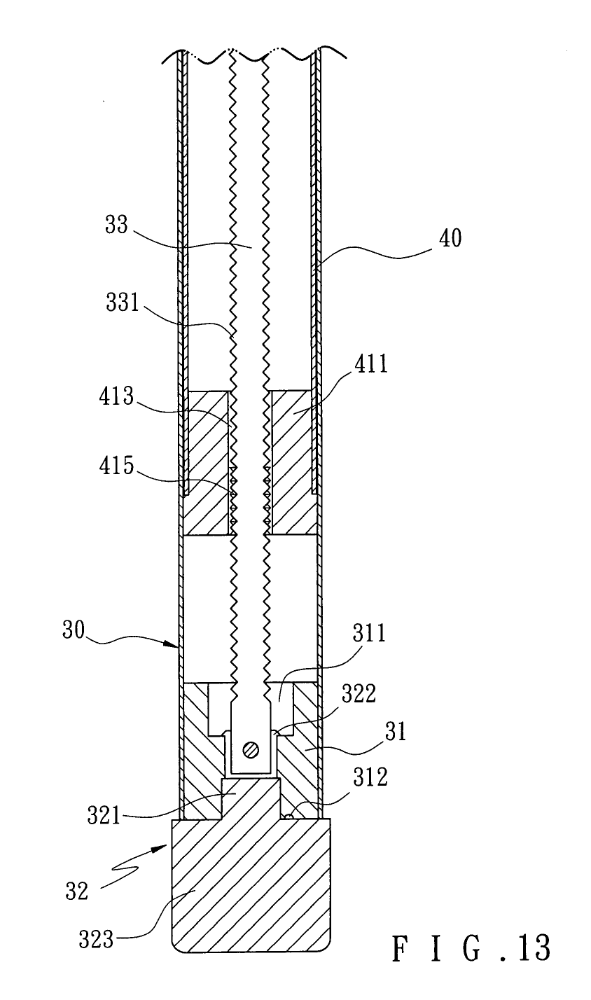

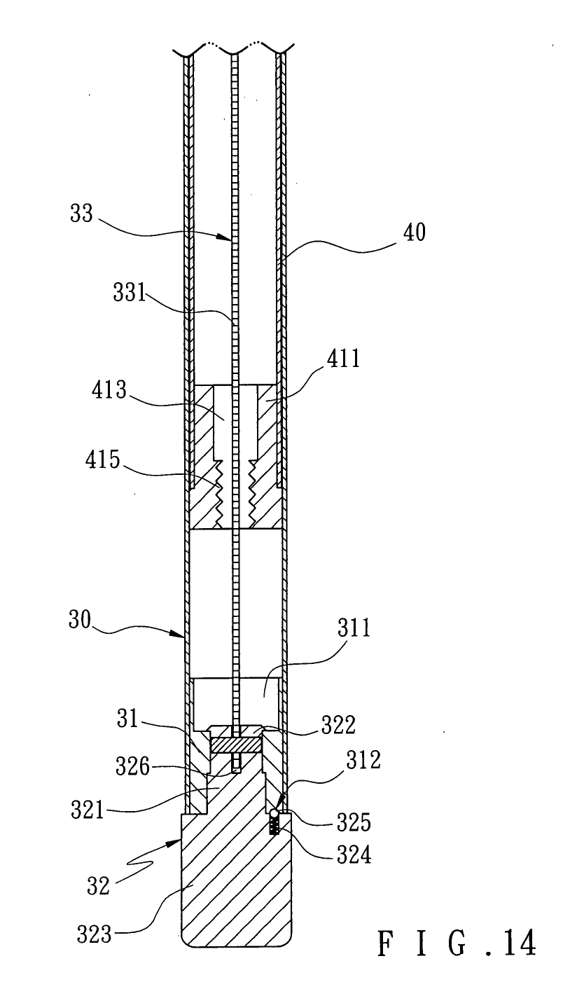

With reference to FIGS. 12-14, in another embodiment of the present invention, no compartment formed in the support seat 41 and toothed block 42 are required, wherein the through hole 413 includes retaining teeth 415 directly formed therein, hence during the length's adjustment of the tubular members, the teeth 331 of the rack 33 do not engage with the retaining teeth 415, such that as the first tubular member 30 is pulled out backward, the rack 33 simultaneously moves backward, thereby achieving the desired length.

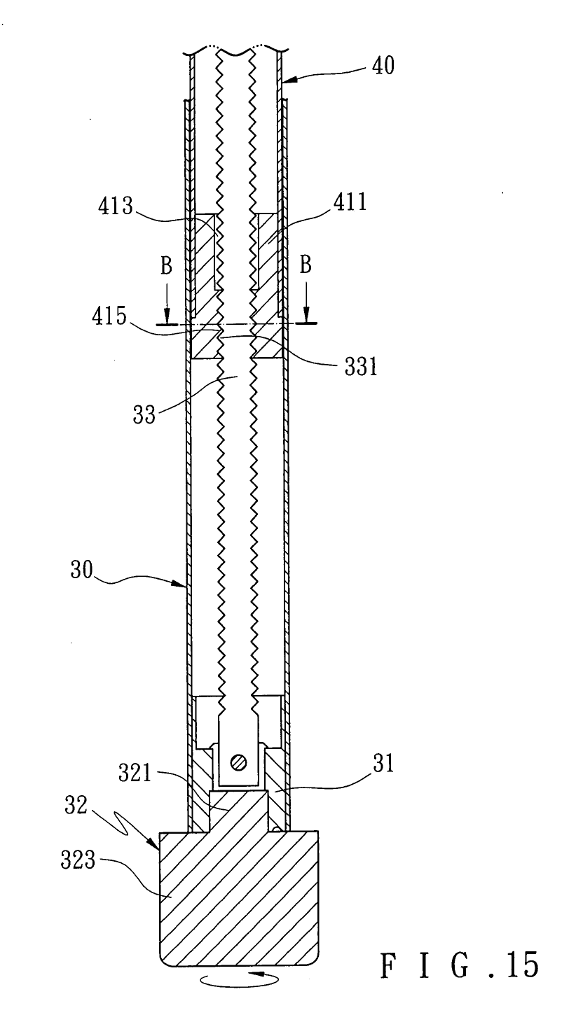

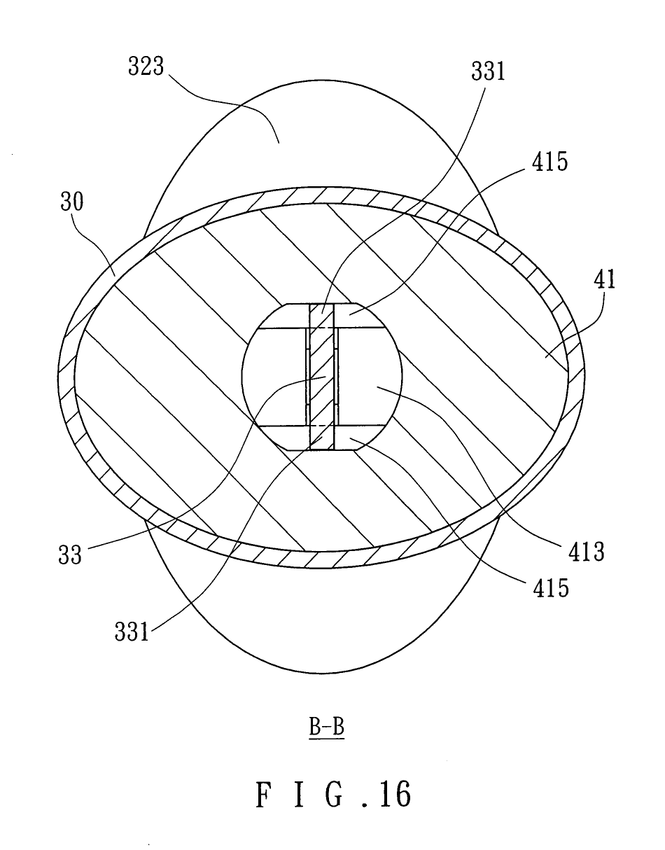

Referring further to FIGS. 15 and 16, after the length's adjustment of the members, the rotatable member 323 may be rotated to urge the rack 33 to turn simultaneously, and the teeth 331 intersect and further engage with the retaining teeth 415, achieving the positioning purpose.

The invention is not limited to the above embodiment but various modifications thereof may be made. It will be understood by those skilled in the art that various changes in form and detail may made without departing from the scope and spirit of the present invention.

What is claimed is:

1. An expandable and retractable positioning device for use in tubular members comprising:
a first tubular member;
a receiving mount received at the rear end of said first tubular member and including a rotatory rack disposed therein;
a second tubular member fitted in said first tubular member;
a support seat attached at the rear end of said second tubular member and including a through hole formed therein and having retaining teeth arranged therein for the engagement with said rack of said receiving mount.

2. The expandable and retractable positioning device for use in tubular members as claimed in claim 1, wherein said receiving mount includes a hole formed therethrough, and includes a control knob fitted at the rear end thereof for receiving said rack therein, such that said rack allows to rotate in said receiving mount.

3. The expandable and retractable positioning device for use in tubular members as claimed in claim 2, wherein said control knob has an insertion provided at the front end thereof for being inserted in said hole of said receiving mount, said insertion includes a retainer affixed at the front end thereof, by which said control knob is retained at the rear end of said receiving mount to actuate the rotation of said rack in said receiving mount.

4. The expandable and retractable positioning device for use in tubular members as claimed in claim 2, wherein said control knob involves a rotatable member secured at the rear end thereof for actuating the rotation of said control knob in said receiving mount.

5. The expandable and retractable positioning device for use in tubular members as claimed in claim 4, wherein said rotatable member includes a spring and a fastening ball defined at the front end thereof, and said receiving mount includes an orifice formed thereon for aligning with said fastening ball.

6. The expandable and retractable positioning device for use in tubular members as claimed in claim 1, wherein said support seat includes a holding member disposed at the rear end thereof, and includes a through hole for inserting said rack into said second tubular member.

7. The expandable and retractable positioning device for use in tubular members as claimed in claim 6, wherein said holding member contains compartments for communicating with said through hole mounted at the peripheral side thereof and each having a toothed block placed therein and provided with engaging teeth arranged on the inner side thereof relative to said through hole.

8. The expandable and retractable positioning device for use in tubular members as claimed in claim 7, wherein said toothed block is lower than the outer surface of said holding member for a tiny displacement in said compartment.

9. An expandable and retractable positioning device for use in tubular members comprising:
a first tubular member;
a receiving mount received at the rear end of said first tubular member and includes a hole formed therethrough;
a control knob fitted at the rear end of said receiving mount for receiving a rack therein;
a second tubular member fitted in said first tubular member;
a support seat including a fitting portion fixed at the front end thereof for being received at the rear end of said second tubular member, and including a through hole for inserting said rack therein, and including a holding member disposed at the rear end thereof and having retaining teeth arranged thereon for the engagement with said rack.

10. The expandable and retractable positioning device for use in tubular members as claimed in claim 9, wherein said control knob includes an insertion provided at the front end thereof for being inserted in said hole of said receiving mount, said insertion includes a retainer affixed at the front end thereof, by which said control knob is retained at the rear end of said receiving mount to actuate the rotation of said rack in said receiving mount.

11. The expandable and retractable positioning device for use in tubular members as claimed in claim 9, wherein said control knob involves a rotatable member secured at the rear end thereof for actuating the rotation of said control knob in said receiving mount.

12. The expandable and retractable positioning device for use in tubular members as claimed in claim 11, wherein said rotatable member includes a spring and a fastening ball defined at the front end thereof, and said receiving mount includes an orifice formed thereon for aligning with said fastening ball.

13. The expandable and retractable positioning device for use in tubular members as claimed in claim 9, wherein said holding member contains compartments for communicating with said through hole mounted at the peripheral side thereof and each having a toothed block placed therein and provided with engaging teeth arranged on the inner side thereof relative to said through hole.

14. The expandable and retractable positioning device for use in tubular members as claimed in claim 9, wherein said toothed block is lower than the outer surface of said holding member for a tiny displacement in said compartment.

15. An expandable and retractable positioning device for use in tubular members comprising:
a first tubular member;
a receiving mount received at the rear end of said first tubular member and including a hole formed therethrough;
a control knob fitted at the rear end of said receiving mount for receiving a rack therein;
a second tubular member fitted in said first tubular member;
a support seat including a fitting portion fixed at the front end thereof for being received at the rear end of said second tubular member, and including a through hole for inserting said rack therein having engaging teeth arranged on the inner side thereof for the engagement with said rack.

16. The expandable and retractable positioning device for use in tubular members as claimed in claim 15, wherein said control knob includes an insertion provided at the front end thereof for being inserted in said hole of said receiving mount, said insertion includes a retainer affixed at the front end thereof, by which said control knob is retained at the rear end of said receiving mount to actuate the rotation of said rack in said receiving mount.

17. The expandable and retractable positioning device for use in tubular members as claimed in claim 15, wherein said control knob involves a rotatable member secured at the rear end thereof for actuating the rotation of said control knob in said receiving mount.

18. The expandable and retractable positioning device for use in tubular members as claimed in claim 17, wherein said rotatable member includes a spring and a fastening ball defined at the front end thereof, and said receiving mount includes an orifice formed thereon for aligning with said fastening ball.
